(19) United States
(12) Patent Application Publication
(10) Pub. No.: US 2024/0100872 A1
(43) Pub. Date: Mar. 28, 2024

(54) TRANSFER PRINTING METHOD OF UV DIGITAL STACKED THICKNESS PRINTING

(71) Applicant: GREAT COMPUTER CORP., New Taipei City (TW)

(72) Inventors: Chen-Chien TSAI, New Taipei City (TW); Liang SHIH, New Taipei City (TW)

(21) Appl. No.: 18/071,062

(22) Filed: Nov. 29, 2022

(30) Foreign Application Priority Data
Sep. 26, 2022 (TW) 111136385

(51) Int. Cl. B41M 5/025; B41J 2/005; B41J 3/407; B41J 11/00

(52) U.S. Cl. CPC B41M 5/0256; B41J 2/0057; B41J 3/4073; B41J 11/00214

(57) ABSTRACT

A transfer-printing method of UV-digital stacked-thickness printing, which comprising following steps of: ink jetting a UV-ink on a carrier with low-adhesive-strength to the carrier to output a color-ink-layer with a mirrored-pattern and fully curing the color-ink-layer through UV-light-irradiation; ink jetting on the color-ink-layer to output a transparent-ink-layer with the same mirrored-pattern processed with gray-scale or binary-conversion, the transparent-ink-layer is divided into a plurality of regions, an inkjet-head ink jets back and forth within one region for multiple times and after ink jets the last time, cures the region through UV-light-irradiation with a low-irradiation-intensity, then the inkjet head moves forward to next region and ink jets back and forth within that region for multiple times; and pressing and transferring the transparent-ink-layer on the carrier onto a workpiece. The method can also be implemented on a foil-sleeking-pattern, such that the foil-surface of a metal-foil is transferred and presented on the workpiece.

### FIELD OF THE INVENTION

The present invention is related to a transfer printing method of UV digital stacked thickness printing, especially to a method that can simply transfer, in the manner of direct transfer after printing, the foil sleeking patterns or the printed patterns with thickness to the curved surfaces that cannot be directly printed or larger objects that cannot be directly placed on a printer.

### BACKGROUND OF THE INVENTION

Due to the advancement of printing technology, now printing equipment can print on the upper surface of soft object to be printed (such as paper, cloth or other textiles) or hard object to be printed (such as plastic, metal, glass or ceramic), making it widely used in various industrial fields, in order to increase the visual effect of the appearance of goods. The current printing methods mainly include traditional printing and digital printing.

Since UV digital printing can be applied to a variety of materials, and UV ink is more environmentally friendly than solvent-based inks, it has been widely used and has gradually become the mainstream of digital image output. However, UV digital printing machines still cannot overcome the limitation that traditional digital printing machines can only print on flat objects. Generally, digital printing on simple curved surfaces (the highest and lowest points of the curved surface does not exceed 3 mm) can only be achieved in one direction and at a lower printing speed with large ink droplets, and only special types of inkjet heads can achieve this. During the printing process, the curved surface will also reflect the UV curing light source, which increases the damage rate of the inkjet head. Furthermore, due to the physical limitations of the ink droplets ejection path, not all the curved surfaces in different directions on the object can obtain the same printing effect, and because of the larger ink droplets, the resolution of the printed images is lower than the general printing quality. Therefore, the above mentioned method is not widely used. Moreover, there are other methods to print the images onto the special materials first and then implement transfer or heat transfer onto the objects, but the procedures are more complicated and must be implemented with special materials or additional equipment (such as thermal laminator or a heat press, etc.).

Furthermore, the above mentioned method also cannot perform foil sleeking and cannot solve the deformation problem of the transferred image and air bubble problem after transfer.

### SUMMARY OF THE INVENTION

Although the industry has proposed several methods to overcome this innate limitation, some of these methods must sacrifice printing quality and productivity, and some require the use of special materials and cooperate with other equipment to indirectly perform transfer with complicate procedures. The above mentioned methods also cannot perform foil sleeking and cannot solve the deformation problem of the transferred image and air bubble problem after transfer. Therefore, how to effectively solve the printing problem on objects with special curved surfaces or larger objects that cannot be directly placed on the printer has always been the research direction of the inventor.

The main purpose of the present invention is to provide a transfer printing method of UV digital stacked thickness printing with a low cost and easy process. The transfer printing method can simply transfer, in the manner of direct transfer after printing, the foil sleeking patterns or the printed patterns with thickness to the curved surfaces that cannot be directly printed or larger objects that cannot be directly placed on a printer.

In order to achieve the above object, the present invention provides a transfer printing method of UV digital stacked thickness printing, which mainly comprises following steps of:
Step a: ink jetting a UV ink on a carrier to output a color ink layer with a mirrored pattern and fully curing the color ink layer through UV light irradiation, wherein the UV ink has low adhesive strength to the carrier;
Step b: ink jetting on the color ink layer to output a transparent ink layer with the same mirrored pattern processed with gray scale or binary conversion, wherein the transparent ink layer is divided into a plurality of regions, the inkjet head ink jets back and forth within one region for multiple times and after ink jets the last time within the region, cures the region through UV light irradiation with a low irradiation intensity, then the inkjet head moves forward to next region and ink jets back and forth within the region for multiple times;
Step c: finally, pressing and transferring the transparent ink layer on the carrier onto a workpiece, such that the color ink layer is presented on the workpiece after the color ink layer is released from the carrier.

In implementation, the low irradiation intensity of the UV light irradiation in the Step b is below 30% of an irradiation intensity of the UV light irradiation that the UV ink is capable of being fully cured.

In implementation, after the color ink layer is fully cured in the Step a, ink jetting on the color ink layer to output a white color ink layer with the same mirrored pattern processed with gray scale or binary conversion, and fully curing the white color ink layer through UV light irradiation.

In implementation, the carrier is a release film, a silicone pad, a polypropylene film, or a Teflon film that has low adhesive strength to the UV ink.

The method can also be implemented on a foil sleeking pattern, such that the foil surface of a metal foil is transferred and presented on the workpiece. The method comprises following steps of:

Step x: providing a foil sleeking film, the foil sleeking film is formed by coating a metal foil to a release film, the metal foil has a front side and a back side, the front side of the metal foil has a foil surface coated to the release film with low adhesive strength to the release film, the back side of the metal foil is used for outputting a color ink layer with a mirrored pattern by ink jetting a UV ink on the back side of the metal foil and then fully curing the color ink layer through UV light irradiation;
Step y: ink jetting on the color ink layer to output a transparent ink layer with the same the mirrored pattern processed with gray scale or binary conversion, wherein the transparent ink layer is divided into a plurality of regions, an inkjet head ink jets back and forth within one region for multiple times and after ink jets the last time, cures the region through UV light irradiation with a low irradiation intensity, then the inkjet head moves forward to next region and ink jets back and forth within that region for multiple times; and
Step z: finally, pressing and transferring the transparent ink layer on the back side of the metal foil onto a workpiece, and releasing the release film such that the color ink layer and the foil surface are together presented on the workpiece.

In implementation, after the color ink layer is fully cured in the Step x, ink jetting on the color ink layer to output a white color ink layer with the same mirrored pattern processed with gray scale or binary conversion, and fully curing the white color ink layer through UV light irradiation.

In implementation, the low irradiation intensity of the UV light irradiation in the Step y is below 30% of an irradiation intensity of the UV light irradiation that the UV ink is capable of being fully cured.

For further understanding the characteristics and effects of the present invention, some preferred embodiments referred to drawings are in detail described as follows.

### BRIEF DESCRIPTION OF DRAWINGS

FIG. 1 is a flow chart of an embodiment of a transfer printing method of the present invention.

FIG. 2 is a schematic perspective view of an embodiment of the present invention after being transferred onto the workpiece.

FIG. 3 is a schematic diagram of an embodiment of steps of a transfer printing method of the present invention.

FIG. 4 is a flow chart of an embodiment of a transfer printing method of the present invention when applied to foil sleeking.

### DETAILED DESCRIPTIONS OF PREFERRED EMBODIMENTS

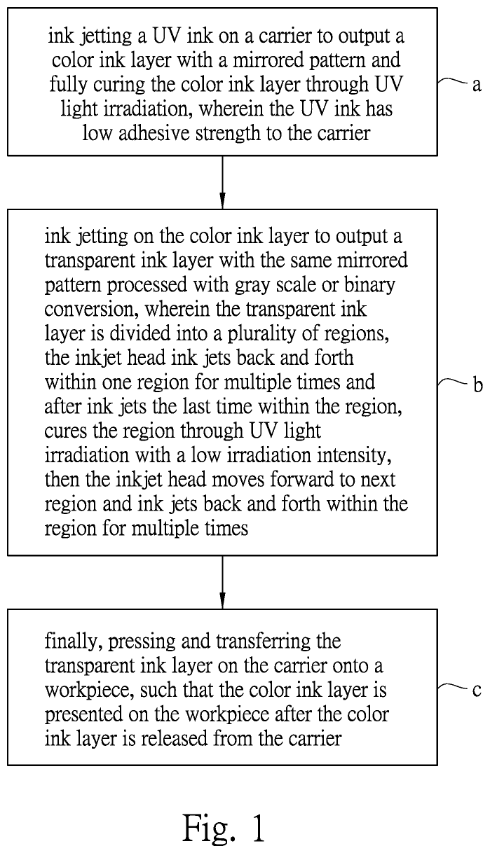

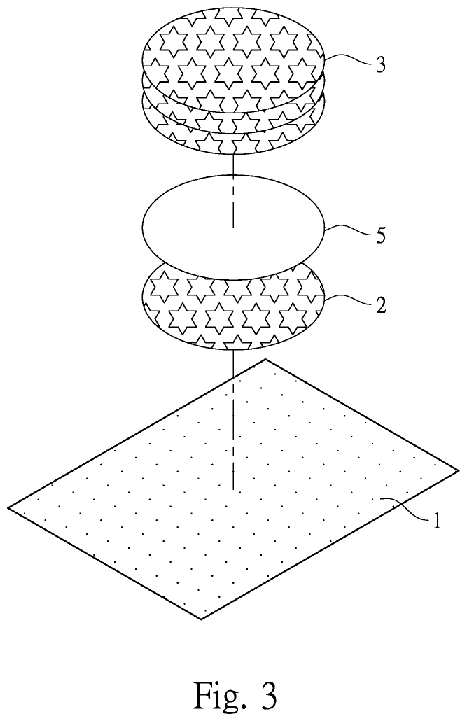

Please refer to FIGS. 1-3, which show the flow chart of an embodiment of a transfer printing method of UV digital stacked thickness printing of the present invention.

A transfer printing method of UV digital stacked thickness printing of the present invention mainly comprises following steps of:
Step a: ink jetting a UV ink on a carrier to output a color ink layer with a mirrored pattern and fully curing the color ink layer through UV light irradiation, wherein the UV ink has low adhesive strength to the carrier;
Step b: ink jetting on the color ink layer to output a transparent ink layer with the same mirrored pattern processed with gray scale or binary conversion, wherein the transparent ink layer is divided into a plurality of regions, the inkjet head ink jets back and forth within one region for multiple times and after ink jets the last time within the region, cures the region through UV light irradiation with a low irradiation intensity, then the inkjet head moves forward to next region and ink jets back and forth within the region for multiple times;
Step c: finally, pressing and transferring the transparent ink layer on the carrier onto a workpiece, such that the color ink layer is presented on the workpiece after the color ink layer is released from the carrier.

The carrier 1 is a release film, a silicone pad, a Polypropylene film or a Teflon film that has low adhesive strength to the UV ink. The low irradiation intensity of the UV light irradiation in the Step b is below 30% of an irradiation intensity of the UV light irradiation that the UV ink is capable of being fully cured.

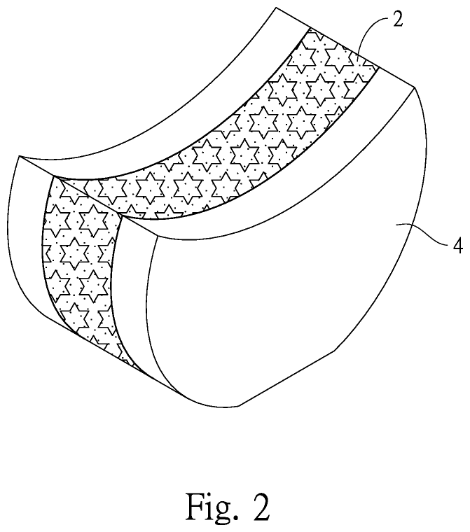

Therefore, in the implementation, taking the workpiece in FIG. 2 as the block structure with large curved surface as an example. Firstly, ink jetting on the carrier 1 (release film) to output a color ink layer 2 with a mirrored pattern on the carrier 1 (release film), wherein the mirrored pattern is the mirror of a pattern to be printed on the workpiece 4; and then fully curing the color ink layer 2 through UV light irradiation (i.e. the color ink layer 2 is fully cured). And then ink jetting on the color ink layer 2 to output a transparent ink layer 3 with the same mirrored pattern processed with gray scale or binary conversion. The transparent ink layer 3 is divided into, for example, 10 regions; the inkjet head can ink jet back and forth within each region for 5 times, for example. When the inkjet head ink jets back and forth within one region for 5 times, after the inkjet head ink jets for the last time (the fifth time), curing the region through UV light irradiation with a low irradiation intensity. Then the inkjet head moves forward to next region and ink jets back and forth within the region for 5 times, until all 10 regions are outputted. At this time, the transparent ink layer 3 is under a semi-cured state; hence, it has some degrees of stickiness. Therefore, finally, pressing and transferring the transparent ink layer 3 on the carrier 1 onto the workpiece 4, such that the color ink layer 2 with the pattern is presented on the workpiece 4.

Furthermore, after the color ink layer 2 is fully cured in the Step a, ink jetting on the color ink layer 2 to output a white color ink layer 5 with the same mirrored pattern processed with gray scale or binary conversion, and fully curing the white color ink layer 5 through UV light irradiation. In this way, the color ink layer 2 can be presented on the white color ink layer 5 during transfer printing, such that the transfer printing process can be smoother and the integrity of the color ink layer 2 can be protected.

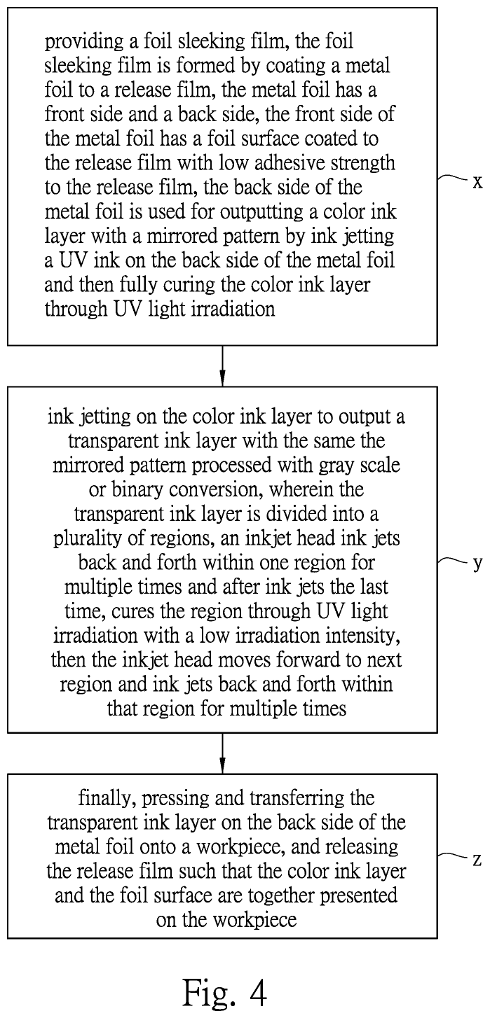

And the above mentioned transfer printing method can also be applied to foil sleeking patterns. As shown in FIG. 4, the complete steps of the method are as follows:

Step x: providing a foil sleeking film, the foil sleeking film is formed by coating a metal foil to a release film, the metal foil has a front side and a back side, the front side of the metal foil has a foil surface coated to the release film with low adhesive strength to the release film, the back side of the metal foil is used for outputting a color ink layer with a mirrored pattern by ink jetting a UV ink on the back side of the metal foil and then fully curing the color ink layer through UV light irradiation;

Step y: ink jetting on the color ink layer to output a transparent ink layer with the same the mirrored pattern processed with gray scale or binary conversion, wherein the transparent ink layer is divided into a plurality of regions, an inkjet head ink jets back and forth within one region for multiple times and after ink jets the last time, cures the region through UV light irradiation with a low irradiation intensity, then the inkjet head moves forward to next region and ink jets back and forth within that region for multiple times; and

Step z: finally, pressing and transferring the transparent ink layer on the back side of the metal foil onto a workpiece, and releasing the release film such that the color ink layer and the foil surface are together presented on the workpiece.

After the color ink layer 2 is fully cured in the Step x, ink jetting on the color ink layer 2 to output a white color ink layer 5 with the same mirrored pattern processed with gray scale or binary conversion, and fully curing the white color ink layer 5 through UV light irradiation. The low irradiation intensity of the UV light irradiation in the Step y is below 30% of an irradiation intensity of the UV light irradiation that the UV ink is capable of being fully cured.

Thereby, the present invention has the following advantages:
1. The present invention utilizes the characteristics of the UV ink which has poor low adhesive strength to certain materials (such as release film, silicone pad, Polypropylene film, Teflon film and etc.), to firstly print out the mirrored pattern of the desired output pattern on these release carrier materials. Then use the above steps to print out a layer of slightly-cured ink layer with stickiness, and then to press the mirrored pattern onto the curved surface or the workpiece to be transferred. Finally, remove the release materials to complete the transferring process. Due to the continuous reaction characteristics of the half-cured or slightly-cured ink, good adhesion can be obtained after being placed for several hours or good adhesion can be obtained immediately to directly cure the half-cured or slightly-cured ink through UV light. Through the method of the present invention, the curved surfaces that cannot be directly printed or larger objects that cannot be directly placed on the printer can be dealt with, so that the pattern can be outputted on the workpiece effectively and quickly.
2. The present invention can also be implemented on a foil sleeking pattern. Utilizing the structural design of the foil sleeking material (foil sleeking film) in which a metal foil is coated to a release film, wherein the foil surface of the front side of the metal foil of the foil sleeking material is coated to the release film with low adhesive strength to the release film, such that after the mirrored pattern is ink jetted on the back side of the metal foil through the above mentioned step, the mirrored pattern on the back side of the metal foil is pressed onto a workpiece, after releasing the release film, then the foil surface of the metal foil is transferred and presented on the workpiece. This simply and effectively solves the problem that currently the foil sleeking pattern cannot be transfer printed to objects with special curved surfaces or larger objects.

As disclosed in the above description and attached drawings, the present invention can provide a transfer printing method of UV digital stacked thickness printing. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A transfer printing method of UV digital stacked thickness printing, comprising following steps of:
Step a: ink jetting a UV ink on a carrier to output a color ink layer with a mirrored pattern and fully curing said color ink layer through UV light irradiation, wherein said UV ink has low adhesive strength to said carrier;
Step b: ink jetting on said color ink layer to output a transparent ink layer with the same said mirrored pattern processed with gray scale or binary conversion, wherein said transparent ink layer is divided into a plurality of regions, an inkjet head ink jets back and forth within one region for multiple times and after ink jets the last time, cures said region through UV light irradiation with a low irradiation intensity, then said inkjet head moves forward to next region and ink jets back and forth within that region for multiple times; and
Step c: finally, pressing and transferring said transparent ink layer on said carrier onto a workpiece, such that said color ink layer is presented on said workpiece after said color ink layer is released from said carrier.

2. The transfer printing method of UV digital stacked thickness printing according to claim 1, wherein said low irradiation intensity of said UV light irradiation in said Step b is below 30% of an irradiation intensity of said UV light irradiation that said UV ink is capable of being fully cured.

3. The transfer printing method of UV digital stacked thickness printing according to claim 1, wherein after said color ink layer is fully cured in the Step a, ink jetting on said color ink layer to output a white color ink layer with the same said mirrored pattern processed with gray scale or binary conversion, and fully curing said white color ink layer through UV light irradiation.

4. The transfer printing method of UV digital stacked thickness printing according to claim 1, wherein said carrier is a release film, a silicone pad, a Polypropylene film or a Teflon film that has low adhesive strength to said UV ink.

5. A transfer printing method of UV digital stacked thickness printing, comprising following steps of:
Step x: providing a foil sleeking film, said foil sleeking film is formed by coating a metal foil to a release film, said metal foil has a front side and a back side, said front side of said metal foil has a foil surface coating to said release film with low adhesive strength to said release film, said back side of said metal foil is used for outputting a color ink layer with a mirrored pattern by ink jetting a UV ink on said back side of said metal foil and then fully curing said color ink layer through UV light irradiation;
Step y: ink jetting on said color ink layer to output a transparent ink layer with the same said mirrored pattern processed with gray scale or binary conversion, wherein said transparent ink layer is divided into a plurality of regions, an inkjet head ink jets back and forth within one region for multiple times and after ink jets the last time, cures said region through UV light irradiation with a low irradiation intensity, then said inkjet head moves forward to next region and ink jets back and forth within that region for multiple times; and
Step z: finally, pressing and transferring said transparent ink layer on said back side of said metal foil onto a workpiece, and releasing said release film such that said color ink layer and said foil surface are together presented on said workpiece.

6. The transfer printing method of UV digital stacked thickness printing according to claim 5, wherein after said color ink layer is fully cured in said Step x, ink jetting on said color ink layer to output a white color ink layer with the same said mirrored pattern processed with gray scale or binary conversion, and fully curing said white color ink layer through UV light irradiation.

7. The transfer printing method of UV digital stacked thickness printing according to claim 5, wherein said low irradiation intensity of said UV light irradiation in said Step y is below 30% of an irradiation intensity of said UV light irradiation that said UV ink is capable of being fully cured.
